(19) United States
(12) Patent Application Publication
(10) Pub. No.: US 2007/0130278 A1
(43) Pub. Date: Jun. 7, 2007

(54) Home network system

(76) Inventors: Seung-Myun Baek, Kyungsangnam-do (KR); Koon-Seok Lee, Kyungsangnam-do (KR); Hwan-Jong Choi, Busan (KR); Yong-Tae Kim, Kyungsangnam-do (KR); Feel-Young Koo, Busan (KR); Ja-In Koo, Kyungsangnam-do (KR); Seong-Hwan Kang, Kyungsangnam-do (KR)

Correspondence Address: MCKENNA LONG & ALDRIDGE LLP, 1900 K STREET, NW, WASHINGTON, DC, 20006, US

(21) Appl. No.: 10/558,433

(22) PCT Filed: Feb. 12, 2004
(86) PCT No.: PCT/KR04/00283

§ 371 Date: Feb. 12, 2007

(30) Foreign Application Priority Data
May 30, 2003 (KR) 10-2003-0034962
Feb. 6, 2004 (KR) 10-2004-0007868

(51) Int. Cl. G06F 15/16

(52) U.S. Cl. 709/208

(57) ABSTRACT

The present invention discloses a home network system which can achieve communication between a home master device and a remote control server by using a predetermined message structure. The home network system includes a home master device connected to a plurality of home appliances, and a remote control server connected to the home master device through a first network, for transmitting/receiving a message between a user terminal and the home master device. The message transmitted/received between the home master device and the remote control server includes at least a product code unit of the corresponding home appliance, a message code unit for notifying a transmission/reception direction of the message, parameter units under the definition of the message, and a number unit of parameters.

### TECHNICAL FIELD

The present invention relates to a home network system, and more particularly to, a home network system which can achieve communication between a home master device and a remote control server by using a predetermined message structure.

### BACKGROUND ART

Home automation for automatically controlling home appliances at home or remotely has almost reached a commercial use stage. At its early stage, the home automation separately controlled each home appliance by using a telephone or infrared rays, and did not connect the home appliances. However, there has been suggested a method for building a network of home appliances by using a communication means, and collectively managing the network by using a controller.

FIG. 1 is a structure view illustrating a general home network system. Referring to FIG. 1, a home network connects various digital home appliances so that a user can always enjoy convenient, safe and economical life services inside or outside the house.

As factors of the advent of the home network, refrigerators or washing machines called white home appliances have been gradually d igitalized due to development of digital signal processing techniques, and new information home appliances have been made due to rapid development of home appliance operating system techniques and high speed multimedia communication techniques.

Here, an IT network is built to exchange data between a personal computer and peripheral devices o r provide internet s ervices, and an AV network is built between home appliances using audio or video informaton. In addition, a living network is built to simply control home appliances, such as home automation or remote meter reading, and may be comprised of a refrigerator, washing machine, microwave oven, electric lamp, gas alarm, air conditioner and telephone.

The home network system includes a master device which is a home appliance for controlling an operation of the other home appliances or monitoring a status thereof, and a slave device which is a home appliance having a function of responding to the request of the master device and a function of notifying a status change according to properties of the home appliances or other factors. Here, the home appliances include home appliances for the living network service such as a washing machine and a refrigerator as well as home appliances for the IT network service and the AV network service.

However, the conventional home network system does not provide a message defined as a predetermined type between the master device and a remote control server for transmitting/receiving a monitoring command and a control command for the home appliances to/from the master device.

### DISCLOSURE OF THE INVENTION

An object of the present invention is to provide a home network system which can provide a message defined as a predetermined type between a remote control server and a master device.

Another object of the present invention is to provide a home network system which can achieve normalization in operation through a normalized message, by using a predefined message having information on a monitoring command and a control command for home appliances.

In order to achieve the above-described objects of the invention, there is provided a home network system including: a home master device connected to a plurality of home appliances; and a remote control server connected to the home master device through a first network, for transmitting/receiving a message between a user terminal and the home master device, wherein the message transmitted/received between the home master device and the remote control server includes at least a product code unit of the corresponding home appliance, a message code unit for notifying a transmission/reception direction of the message, parameter units under the definition of the message, and a number unit of parameters.

Preferably, the product code unit includes a product ID code and a logical address of the home appliance, the product ID code and the logical address of the product code unit are formed without an empty space, and the product code unit includes at least characters.

Preferably, the message code unit includes numbers.

Preferably, the message code unit includes at least one of a first code region for displaying a message from the home master device to the remote control server, and a second code region for displaying a message from the remote control server to the home master device.

Preferably, the first code region and the second code region do not overlap with each other.

Preferably, the first and second code regions include numbers.

Preferably, the product code unit, the message code unit, the parameter units and the number unit of the parameters are distinguished by predetermined delimiters.

Preferably, the message sequentially includes the product code unit, the message code unit, the number unit of the parameters, and the parameter units.

Preferably, the message is a message for basic communication, and the basic communication includes at least one of login request and response, a dummy message, and logout request and response.

Preferably, each of the parameter units includes a user ID code unit, an internet operation program code command unit for identifying the home appliance, a command unit for the home appliance, return argument units, and a number unit of return arguments.

Preferably, each of the parameter units sequentially includes the user ID code unit, the internet operation program code command unit, the command unit for the home appliance, the number unit of the return arguments, and the return argument units.

Preferably, the user ID code unit, the internet operation program code command unit, the command unit for the home appliance, the number unit of the return arguments and the return argument units are distinguished by predetermined delimiters.

Preferably, the message is a message for monitoring the home appliance.

Preferably, the user ID code unit includes characters.

Preferably, the internet operation program code command unit includes a recognition code for an internet operation program, a product ID code and a command, and more preferably, the internet operation program code command unit has a type of ‘recognition code=product ID code_command’.

Preferably, the command unit for the home appliance includes a factor name and a factor value of the command, and more preferably, the command unit for the home appliance has a type of ‘factor name=factor value’.

Preferably, each of the return argument units includes a return argument name and a factor value, and more preferably, each of the return argument units has a type of ‘name=factor value’.

Preferably, each of the return argument units further includes a byte number of the factor value.

Preferably, each of the parameter units includes a user ID code unit, a destination IP unit of the home master device, an internet operation program code command unit for identifying the home appliance, a command unit for the home appliance, argument units, and a number unit of arguments.

Preferably, each of the parameter units sequentially includes the user ID code unit, the destination IP unit, the internet operation program code command unit, the command unit for the home appliance, the number unit of the arguments, and the argument units.

Preferably, the user ID code unit, the destination IP unit, the internet operation program code command unit, the command unit for the home appliance, the number unit of the arguments and the argument units are distinguished by predetermined delimiters.

Preferably, the message is a control message for the home appliance.

Preferably, each of the parameter units further includes a language unit for displaying a kind of a language.

Preferably, the language unit is included between the destination IP unit and the internet operation program code command unit.

Preferably, the user ID code unit includes characters.

Preferably, the internet operation program code command unit includes a recognition code for an Internet operation program, a product ID code and a command, and more preferably, the Internet operation program code command unit has a type of ‘recognition code=product name_command’.

Preferably, the command unit for the home appliance includes a factor name and a factor value of the command, and more preferably, the command unit for the home appliance has a type of ‘factor name=factor value’.

Preferably, each of the argument units includes an argument name and a factor value, and more preferably, each of the argument units has a type of ‘name=factor value’.

Preferably, each of the argument units further includes a byte number of the factor value.

Preferably, the message further includes an ID code of the user terminal.

According to one aspect of the invention, a storage medium for recording a message in a home network system, the home network system including a home master device connected to a plurality of home appliances, and a remote control server connected to the home master device through a first network, for transmitting/receiving a message between a user terminal and the home master device, the message used for the home network system includes at least a product code unit of the corresponding home appliance, a message code unit for notifying a transmission/reception direction of the message, parameter units under the definition of the message, and a number unit of parameters.

### BRIEF DESCRIPTION OF THE DRAWINGS

The present invention will become better understood with reference to the accompanying drawings which are given only by way of illustration and thus are not limitative of the present invention, wherein:

FIG. 1 is a structure view illustrating a general home network system;

FIG. 2 is a structure view illustrating a home network system in accordance with the present invention; and

FIG. 3 is a structure view illustrating a message transmitted in the home network system of FIG. 2.

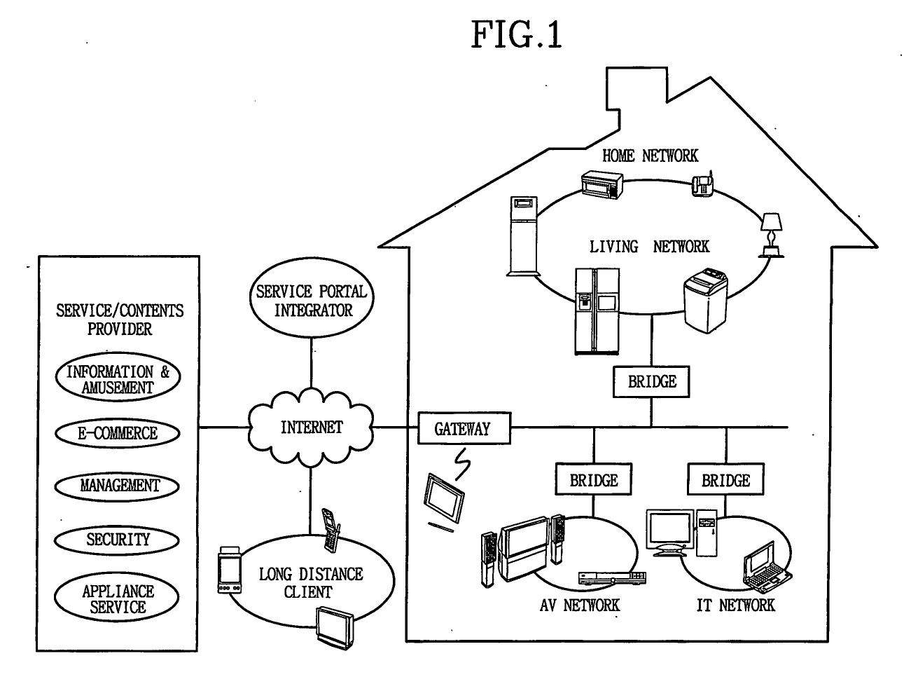

### BEST MODE FOR CARRYING OUT THE INVENTION

A home network system in accordance with the present invention will now be described in detail with reference to the accompanying drawings.

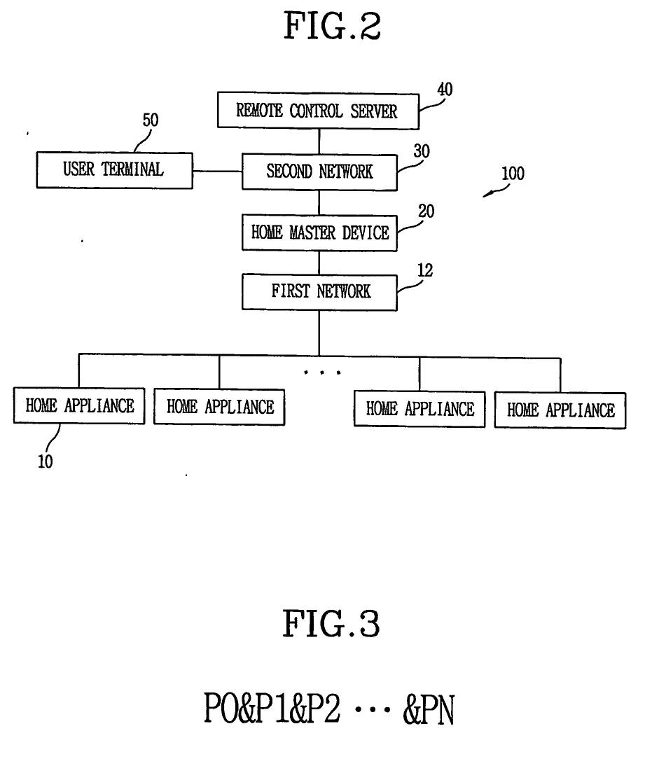

FIG. 2 is a structure view illustrating the home network system in accordance with the present invention. Referring to FIG. 2, the home network system 100 includes a plurality of home appliances 10, a home master device 20 connected to the plurality of home appliances 10 through a first network 12, for monitoring and controlling the home appliances 10, a second network 30 for performing communication among the home master device 20, a remote control server 40 and a user terminal 50, the remote control server 40 for generating monitoring and control commands, and transmitting the commands to the home master device 20 through the second network 30, and the user terminal 50 for allowing the user to access the remote control server 40 through the second network 30 and monitor or control the home appliances 10 and/or the home master device 20.

In detail, the plurality of home appliances 10 communicate with the home master device 20 through the first network 12. Here, each of the home appliances 10 is registered in the home master device 20, provided with unique logical addresses (for example, 0x00, 0x01, etc.), and identified by the logical addresses.

The first network 12 can be a wire medium such as a specially-installed line, or a power line or telephone line previously installed in a house and/or building, or a wireless transmission medium.

Identically to the aforementioned master device, the home master device 20 monitors and controls the home appliances 10 which are slave devices. The home master device 20 is connected to the remote control server 40 through the second network 30 for basic communication (for example, login request and response, dummy signal, logout request and response, etc.), and monitoring response or control command and response.

When receiving power or an operation start command from the user, the home master device 20 is connected to the remote control server 40 through the second network 20 by a login procedure automatically or by the command of the user. The login procedure is performed by using a general ID and password (ID information stored respectively in the home master device and the remote control server). The home master device 20 transmits a login request message to the remote control server 40, and the remote control server 40 processes the login request message and transmits a login response message to the home master device 20. After the home master device 20 is connected to the remote control server 40 by the login procedure, the home master device 20 transmits a dummy signal (or message) to the remote control server 40 at a predetermined time interval in order to confirm communication access. In addition, the home master device 20 transmits a logout request message to the remote control server 40 by a logout procedure, and the remote control server 40 processes the logout request message and transmits a logout response message to the home master device 20.

The second network 30 includes, for example, an Internet, and further includes other constitutional elements according to a kind of the user terminal 50. That is, when the user terminal 50 is a computer, a web server (not shown) is connected between the second network 30 and the user terminal 50, and when the user terminal 50 is an internet phone, a Wap server (not shown) is connected between the second network 30 and the user terminal 50.

The first network 12 and the second network 30 are separated networks. The first network 12 composes a closed network (separated from the second network) for connecting the home appliances through a wire or wireless transmission medium. Here, the closed network includes a physically-connected but logically-divided network.

Thereafter, the remote control server 40 is connected to the home master device 20 and the user terminal 50 by login and logout procedures, for receiving the monitoring and control commands from the user terminal 50, and transmitting them to the home master device 20 through a predetermined type of message. In addition, the remote control server 40 receives a predetermined type of message from the home master device 20, and stores or transmits the message to the user terminal 50.

FIG. 3 is a structure view illustrating the message transmitted in the home network system of FIG. 2. As shown in FIG. 3, the message is transmitted between the home master device 20 and the remote control server 40, and comprised of a plurality of parameters P0 to PN. Each of the parameters P0 to PN is distinguished by predetermined delimiters (for example, &). The parameters P0 to PN and the delimiters are formed without an empty space.

Here, P0 denotes an ID code of a sender (user terminal) regardless of a kind of the message. For example, when a plurality of users access the remote control server 40 through a plurality of user terminals, P0 is required to distinguish the users. However, P0 can be selectively included in the message.

Exemplary messages include a message for basic communication, a message for monitoring and a message for controlling. A parameter P1 denotes a product code unit, a parameter P2 denotes a message code unit, a parameter P3 denotes a number unit of parameters, and parameters P4 to PN denote parameter units under the definition of the message.

The message for basic communication includes the login request and response messages, the dummy signal, and the logout request and response messages. The structure of the message will now be explained.

In detail, the product code unit includes a product ID code and a logical address of the corresponding home appliance 10. For example, the product ID code is a character type, such as ‘CC’ of an air conditioner and ‘Wm’ of a washing machine, and the logical address is a number type, such as ‘0x01’ and ‘0x02’. The product ID code and the logical address of the product code unit are consecutively formed without an empty space, such as ‘CC01’ and ‘Wm02’.

The message code unit shows a transmission/reception direction of the message, and includes at least one of a first code region for displaying the message from the home master device 20 to the remote control server 40, and a second code region for displaying the message from the remote control server 40 to the home master device 20. For example, the first code region includes numbers of 0 to 99 and the second code region includes numbers of 100 to 199 not to overlap with each other. That is, when the message is transmitted from the home master device 20 to the remote control server 40, the message code unit includes one number of the first code region, for example, ‘4’, and when the message is transmitted from the remote control server 40 to the home master device 20, the message code unit includes one number of the second code region, for example, ‘110’.

Each of the parameter units has values under the definition of the message, and the number unit of the parameters displays a number N-3 of the parameters.

The product code unit, the message code unit, the parameter units and the number unit of the parameters are distinguished by predetermined delimiters (for example, &). The message sequentially includes the product code unit, the message code unit, the number unit of the parameters, and the parameter units.

The message includes the message for monitoring the home appliance 10. Here, the message includes the product code unit, the message code unit and the number unit of the parameters of the message for basic communication, and also includes different parameters P4 to PN.

In detail, each of the parameter units includes a user ID code unit P4, an internet operation program code command unit P5 for identifying the home appliance 10, a command unit P6 for the home appliance 10, a number unit P7 of return arguments, and return argument units P8 to PN.

The user ID code unit P4 corresponds to the ID of the login information registered in the remote control server 40, and includes at least characters. For example, the user ID code unit P4 is used in the form of ‘id=jaeeny’.

The internet operation program code command unit P5 includes a recognition code iopc for an internet operation program, a product ID code and a command, and has a type of ‘recognition code=product ID code_command’. For example, the internet operation program code command unit P5 includes ‘iopc=wm_exe_message’, which implies an execution message exe_message for a washing machine wm, and may also include ‘file_down_send’ for downloading a predetermined file to the home master device 20.

The command unit P6 includes a factor name and a factor value of the command, and has a type of ‘factor name comm_code=factor value’. For example, the command unit P6 includes ‘comm_code=209’. Here, the factor value includes a command for the home appliance 10.

The number unit P7 of the return arguments implies a number N-7 of the return arguments.

Each of the return argument units P8 to PN includes a return argument name and a factor value, and has a type of ‘name=factor value’. For example, the return argument units P8 to PN include ‘A1=300’, ‘ws=0 (washing setting is 0, namely main operation)’, and ‘rs=0 (rinse setting is 0, namely normal)’. In addition, each of the return argument units P8 to PN further includes a byte number of the factor value. For example, when the return argument units P8 to PN include ‘A1=2 300’, the return argument A1 is 2 bytes and has a value of 300.

Each of the parameter units sequentially includes the user ID code unit, the internet operation program code command unit, the command unit, the number unit of the return arguments, and the return argument units. The user ID code unit, the internet operation program code command unit, the command unit, the number unit of the return arguments, and the return argument units are distinguished by predetermined delimiters (for example, &).

Finally, the message includes the control message for the home appliance 10. The control message includes the product code unit, the message code unit and the number unit of the parameters of the message for basic communication, and also includes different parameters P4 to PN.

Each of the parameter units includes a user ID code unit P4, a destination IP unit P5 for the home master device 20, a language unit P6, an internet operation program code command unit P7 for identifying the home appliance 10, a command unit P8 for the home appliance 10, a number unit P9 of arguments, and argument units P10 to PN.

In detail, the user ID code unit P4, the internet operation program code command unit P7 and the command unit P8 are identical to the user ID code unit P4, the internet operation program code command unit P5 and the command unit P6 of the message for monitoring.

The destination IP unit P5 includes an address of the home master device 10. For example, the destination IP unit P5 includes ‘remote_addr=165.186.30.228’. The language unit P6 displays a kind of the language used in the message. For example, the language IP unit P5 includes ‘lang=ko’ or ‘lang=en’. Here, ‘ko’ implies Korean and ‘en’ implies English.

The number unit P9 of the arguments means a number N-9 of the arguments.

Each of the argument units P10 to PN includes an argument name and a factor value, and has a type of ‘name=factor value’. For example, the argument units P10 to PN include ‘A1=300’. In addition, each of the argument units P10 to PN further includes a byte number of the factor value. For example, when the argument units P10 to PN include ‘A1=2_{—}300’, the argument A1 is 2 bytes and has a value of 300.

Each of the argument units P10 to PN sequentially includes the user ID code unit P4, the destination IP unit P5, the language unit P6, the internet operation program code command unit P7, the command unit P8, the number unit P9 of the arguments, and the argument units P10 to PN. Here, the user ID code unit P4, the destination IP unit P5, the language unit P6, the internet operation program code command unit P7, the command unit P8, the number unit P9 of the arguments and the argument units P10 to PN are distinguished by predetermined delimiters (for example, &).

For example, the message can be made out as follows:

‘wm00&171&6&id=jaeeny&remote_addr=165.186.30.228&lang=en&iopc=wm_exe_message&comm_code=5&1’

Here, ‘wm’ denotes a washing machine, ‘0×00’ denotes a logical address of the washing machine, ‘0x05’ denotes a control command code (power control command), and ‘0x01’ denotes a factor (operation command).

As discussed earlier, in accordance with the present invention, the home network system provides the message defined as a predetermined type between the remote control server and the master device.

Furthermore, the home network system achieves normalization in operation through the normalized message, by using the predefined message having the information on the monitoring command and the control command for the home appliances.

Although the preferred embodiment of the present invention has been described, it is understood that the present invention should not be limited to this preferred embodiment but various changes and modifications can be made by one skilled in the art within the spirit and scope of the present invention as hereinafter claimed.

What is claimed is:

1. A home network system, comprising:
a home master device connected to a plurality of home appliances; and
a remote control server connected to the home master device through a first network, for transmitting/receiving a message between a user terminal and the home master device,
wherein the message transmitted/received between the home master device and the remote control server comprises at least a product code unit of the corresponding home appliance, a message code unit for notifying a transmission/reception direction of the message, parameter units under the definition of the message, and a number unit of parameters.

2. The system of claim 1, wherein the product code unit comprises a product ID code and a logical address of the home appliance.

3. The system of claim 2, wherein the product ID code and the logical address of the product code unit are formed without an empty space.

4. The system of any one of claims 1 to 3, wherein the product code unit comprises at least characters.

5. The system of claim 1, wherein the message code unit comprises numbers.

6. The system of claim 1, wherein the message code unit comprises at least one of a first code region for displaying a message from the home master device to the remote control server, and a second code region for displaying a message from the remote control server to the home master device.

7. The system of claim 6, wherein the first code region and the second code region do not overlap with each other.

8. The system of claim 1 or 6, wherein the first and second code regions comprise numbers.

9. The system of claim 1, wherein the product code unit, the message code unit, the parameter units and the number unit of the parameters are distinguished by predetermined delimiters.

10. The system of claim 1 or 9, wherein the message sequentially comprises the product code unit, the message code unit, the number unit of the parameters, and the parameter units.

11. The system of claim 1, wherein the message is a message for basic communication.

12. The system of claim 11, wherein the basic communication comprises at least one of login request and response, a dummy message, and logout request and response.

13. The system of claim 1, wherein each of the parameter units comprises a user ID code unit, an internet operation program code command unit for identifying the home appliance, a command unit for the home appliance, return argument units, and a number unit of return arguments.

14. The system of daim 13, wherein each of the parameter units sequentially comprises the user ID code unit, the internet operation program code command unit, the command unit for the home appliance, the number unit of the return arguments, and the return argument units.

15. The system of claim 13 or 14, wherein the user ID code unit, the internet operation program code command unit, the command unit for the home appliance, the number unit of the return arguments and the return argument units are distinguished by predetermined delimiters.

16. The system of claim 13, wherein the message is a message for monitoring the home appliance.

17. The system of claim 13, wherein the user ID code unit comprises characters.

18. The system of claim 13, wherein the internet operation program code command unit comprises a recognition code for an internet operation program, a product ID code and a command.

19. The system of claim 18, wherein the internet operation program code command unit has a type of ‘recognition code=product ID code_command’.

20. The system of claim 13, wherein the command unit for the home appliance comprises a factor name and a factor value of the command.

21. The system of claim 20, wherein the command unit for the home appliance has a type of ‘factor name=factor value’.

22. The system of claim 13, wherein each of the return argument units comprises a return argument name and a factor value.

23. The system of claim 22, wherein each of the return argument units has a type of ‘name=factor value’.

24. The system of claim 22 or 23, wherein each of the return argument units further comprises a byte number of the factor value.

25. The system of claim 1, wherein each of the parameter units comprises a user ID code unit, a destination IP unit of the home master device, an internet operation program code command unit for identifying the home appliance, a command unit for the home appliance, argument units, and a number unit of arguments.

26. The system of claim 25, wherein each of the parameter units sequentially comprises the user ID code unit, the destination IP unit, the internet operation program code command unit, the command unit for the home appliance, the number unit of the arguments, and the argument units.

27. The system of claim 25 or 26, wherein the user ID code unit, the destination IP unit, the Internet operation program code command unit, the command unit for the home appliance, the number unit of the arguments and the argument units are distinguished by predetermined delimiters.

28. The system of claim 25 or 26, wherein the message is a control message for the home appliance.

29. The system of claim 25 or 26, wherein each of the parameter units further comprises a language unit for displaying a kind of a language.

30. The system of claim 29, wherein the language unit is included between the destination IP unit and the internet operation program code command unit.

31. The system of claim 25, wherein the user ID code unit comprises characters.

32. The system of claim 25, wherein the internet operation program code command unit comprises a recognition code for an internet operation program, a product ID code and a command.

33. The system of claim 32, wherein the internet operation program code command unit has a type of ‘recognition code=product name_command’.

34. The system of claim 25, wherein the command unit for the home appliance comprises a factor name and a factor value of the command.

35. The system of claim 34, wherein the command unit for the home appliance has a type of ‘factor name=factor value’.

36. The system of claim 25, wherein each of the argument units comprises an argument name and a factor value.

37. The system of claim 36, wherein each of the argument units has a type of ‘name=factor value’.

38. The system of claim 36 or 37, wherein each of the argument units further comprises a byte number of the factor value.

39. The system of claim 1, wherein the message further comprises an ID code of the user terminal.

40. A storage medium for recording a message in a home network system, the home network system including a home master device connected to a plurality of home appliances, and a remote control server connected to the home master device through a first network, for transmitting/receiving a message between a user terminal and the home master device, the message used for the home network system comprising at least a product code unit of the corresponding home appliance, a message code unit for notifying a transmission/reception direction of the message, parameter units under the definition of the message, and a number unit of parameters.

41. The storage medium of claim 40, wherein the product code unit comprises a product ID code and a logical address of the home appliance.

42. The storage medium of claim 41, wherein the product ID code and the logical address of the product code unit are formed without an empty space.

43. The storage medium of any one of claims 40 to 42, wherein the product code unit comprises at least characters.

44. The storage medium of claim 40, wherein the message code unit comprises numbers.

45. The storage medium of claim 40, wherein the message code unit comprises at least one of a first code region for displaying a message from the home master device to the remote control server, and a second code region for displaying a message from the remote control server to the home master device.

46. The storage medium of claim 45, wherein the first code region and the second code region do not overlap with each other.

47. The storage medium of claim 40 or 45, wherein the first and second code regions comprise numbers.

48. The storage medium of claim 40, wherein the product code unit, the message code unit, the parameter units and the numbers unit of the parameters are distinguished by predetermined delimiters.

49. The storage medium of claim 40 or 48, wherein the message sequentially comprises the product code unit, the message code unit, the number unit of the parameters, and the parameter units.

50. The storage medium of claim 40, wherein each of the parameter units comprises a user ID code unit, an internet operation program code command unit for identifying the home appliance, a command unit for the home appliance, return argument units, and a number unit of return arguments.

51. The storage medium of claim 50, wherein each of the parameter units sequentially comprises the user ID code unit, the internet operation program code command unit, the command unit for the home appliance, the number unit of the return arguments, and the return argument units.

52. The storage medium of claim 50 or 51, wherein the user ID code unit, the internet operation program code command unit, the command unit for the home appliance, the number unit of the return arguments and the return argument units are distinguished by predetermined delimiters.

53. The storage medium of claim 50, wherein the user ID code unit comprises characters.

54. The storage medium of claim 50, wherein the internet operation program code command unit comprises a recognition code for an internet operation program, a product ID code and a command.

55. The storage medium of claim 54, wherein the internet operation program code command unit has a type of ‘recognition code=product ID code_command’.

56. The storage medium of claim 50, wherein the command unit for the home appliance comprises a factor name and a factor value of the command.

57. The storage medium of claim 56, wherein the command unit for the home appliance has a type of ‘factor name=factor value’.

58. The storage medium of claim 50, wherein each of the return argument units comprises a return argument name and a factor value.

59. The storage medium of claim 58, wherein each of the return argument units has a type of ‘name=factor value’.

60. The storage medium of claim 58 or 59, wherein each of the return argument units further comprises a byte number of the factor value.

61. The storage medium of claim 40, wherein each of the parameter units comprises a user ID code unit, a destination IP unit of the home master device, an internet operation program code command unit for identifying the home appliance, a command unit for the home appliance, argument units, and a number unit of arguments.

62. The storage medium of claim 61, wherein each of the parameter units sequentially comprises the user ID code unit, the destination IP unit, the internet operation program code command unit, the command unit for the home appliance, the number unit of the arguments, and the argument units.

63. The storage medium of claim 61 or 62, wherein the user ID code unit, the destination IP unit, the internet operation program code command unit, the command unit for the home appliance, the number unit of the arguments and the argument units are distinguished by predetermined delimiters.

64. The storage medium of claim 61 or 62, wherein each of the parameter units further comprises a language unit for displaying a kind of a language.

65. The storage medium of claim 64, wherein the language unit is included between the destination IP unit and the internet operation program code command unit.

66. The storage medium of claim 61, wherein the user ID code unit comprises characters.

67. The storage medium of claim 61, wherein the Internet operation program code command unit comprises a recognition code for an internet operation program, a product ID code and a command.

68. The storage medium of claim 67, wherein the internet operation program code command unit has a type of ‘recognition code=product name_command’.

69. The storage medium of claim 61, wherein the command unit for the home appliance comprises a factor name and a factor value of the command.

70. The storage medium of claim 69, wherein the command unit for the home appliance has a type of ‘factor name=factor value’.

71. The storage medium of claim 61, wherein each of the argument units comprises an argument name and a factor value.

72. The storage medium of claim 71, wherein each of the argument units has a type of ‘name=factor value’.

73. The storage medium of claim 71 or 72, wherein each of the argument units further comprises a byte number of the factor value.

74. The storage medium of claim 40, wherein the message further comprises an ID code of the user terminal.
